(19) United States
(12) Patent Application Publication
(10) Pub. No.: US 2012/0185259 A1
(43) Pub. Date: Jul. 19, 2012

(54) TOPIC-BASED CALENDAR AVAILABILITY

(75) Inventors: Haggai Roitman, Qiryat-Ata (IL); Yossi Mesika, Afula (IL)

(73) Assignee: International Business Machines Corporation, Armonk, NY (US)

(21) Appl. No.: 13/008,929

(22) Filed: Jan. 19, 2011

(51) Int. Cl. G06Q 10/00; G06N 5/02

(52) U.S. Cl. 705/1.1; 706/47

(57) ABSTRACT

A method, system, and computer program product for topic-based calendar availability. The method includes having a rule for a time slot in a calendar, wherein the rule includes a rule topic and an availability status for the topic and having a proposed event with an event topic and a time slot. The method compares a proposed event topic and a rule topic for the rule for the time slot of the proposed event and applies a proximity measure to the event topic and rule topic to determine a match. The availability status for the topic is provided if the event topic matches the rule topic, otherwise an alternative availability status is provided.

### BACKGROUND

This invention relates to the field of calendar and scheduling systems. In particular, the invention relates to topic-based calendar availability.

Calendar and scheduling systems have become widespread in use and provide an automated way of making appointments, accepting or declining appointments, and keeping track of scheduled events including reminders. A user may invite participants to an event via a scheduling system that automatically checks participants' availability for the event.

Current collaborative calendar management systems display either binary availability information (for example, either red or green) or use a range of annotations (for example, different colors). The range of annotations may be based on meeting urgency derived by explicit definition of meeting urgency, time proximity of the meeting and its length, or identity of required participants and their roles (for example, required, optional, etc.).

### BRIEF SUMMARY

According to a first aspect of the present invention there is provided a method for topic-based calendar availability, comprising: having a rule for a time slot in a calendar, wherein the rule includes a rule topic and an availability status for the topic; having a proposed event with an event topic and a time slot; comparing a proposed event topic and a rule topic for the rule for the time slot of the proposed event; applying a proximity measure to the event topic and rule topic to determine a match; providing the availability status for the topic if the event topic matches the rule topic; wherein said steps are implemented in either: computer hardware configured to perform said steps, or computer software embodied in a non-transitory, tangible, computer-readable storage medium.

According to a second aspect of the present invention there is provided a computer program product, the computer program product for topic-based calendar availability comprising: a computer readable storage medium having computer readable program code embodied therewith, the computer readable program code comprising: computer readable program code configured to: have a rule for a time slot in a calendar, wherein the rule includes a rule topic and an availability status for the topic; have a proposed event with an event topic and a time slot; compare a proposed event topic and a rule topic for the rule for the time slot of the proposed event; apply a proximity measure to the event topic and rule topic to determine a match; and provide the availability status for the topic if the event topic matches the rule topic.

According to a third aspect of the present invention there is provided a system for topic-based calendar availability, comprising: a processor; a rules component for having a rule for a time slot in a calendar, wherein the rule includes a rule topic and an availability status for the topic; an event component for having a proposed event with an event topic and a time slot; a rule applying component including: a proximity component for comparing a proposed event topic and a rule topic for the rule for the time slot of the proposed event and applying a proximity measure to the event topic and rule topic to determine a match; and an availability component for providing the availability status for the topic if the event topic matches the rule topic.

According to a fourth aspect of the present invention there is provided a method of providing a service to a customer over a network for topic-based calendar availability, the service comprising: having a rule for a time slot in a calendar, wherein the rule includes a rule topic and an availability status for the topic; having a proposed event with an event topic and a time slot; comparing a proposed event topic and a rule topic for the rule for the time slot of the proposed event; applying a proximity measure to the event topic and rule topic to determine a match; and providing the availability status for the topic if the event topic matches the rule topic.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system in accordance with a first aspect of the present invention;

FIG. 2 is a block diagram of a system in accordance with a second aspect of the present invention;

FIG. 3 is a block diagram of a computer system in which the present invention may be implemented;

FIG. 4 is a flow diagram of a method in accordance with a first aspect the present invention;

FIG. 5 is a flow diagram of a method in accordance with a second aspect the present invention; and

FIG. 6 is a flow diagram of a method in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, ^{an} and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The described system relates to a calendar availability definition based on topic for purposes of event scheduling.

The described system enables the feature of scheduling a meeting for a user when a topic of the meeting and planned time of occurrence of the meeting match a topic and availability specified by the user.

Such topic-based availability definition can be used by individuals to define preferred times for meetings/tasks/events participation based on topic or keywords that describe the topic. A definition can be based on the individual's work routine. For example, an individual that does not wish to be invited after regular work hours to meetings that relate to general work topics rather than the specific project that he or she is working on and therefore are less urgent to that individual, can use this new definition to avoid being invited to such meetings. Note that this individual may still be available for all other meetings that relate to his specific project.

Such definition can better assist meeting coordinators to schedule meetings which fit the preferences of individuals not only in terms of available time slots but also according to topic-based availability.

The described system allows an individual to define a context for meeting availability which maps a given topic into free time slots in the individual's calendar. At the time of calendar meeting/task/event scheduling, a coordinator can be notified of the availability of different invitees based on the topic-based availability defined by each individual, helping the coordinator to locate free time slots that will be more focused on the individual topic-based preferences.

Rules are defined by a user including the definitions of:
Time slot or time period.
Topic, plus additional optional metadata.
Match of defined topic to event topic. A threshold of similarity to the topic may be defined. If no threshold is given, a default of 100% similarity is required.
Availability, if match of topic.
Availability, if no match of topic.

In one embodiment the rules may be defined as follows:
FROM <begin date/time interval> TO <end date/time interval> IF TOPIC IS <list of topics> [WITH THRESHOLD <threshold>]THEN MY AVAILABILITY IS <AVAILABLE/NOT AVAILABLE/MAYBE AVAILABLE/OTHER: user defined status>
ELSE MY AVAILABILITY IS <AVAILABLE/NOT AVAILABLE/MAYBE

AVAILABLE/OTHER: user defined status>.
where:
FROM . . . TO: defines a time slot for availability.
IF TOPIC IS: a topic-definition pattern that defines list of topics that constrain the availability within the defined time slot (topics can be written in any form of free text description, combined using OR, AND, NOT logical operators.
WITH THRESHOLD: a threshold definition that can be used by the system to determine the proximity of any meeting/task/event topic invitation to the current rule defined topic. Default value if not specified is 100%, meaning that an exact match to the topic definition pattern is required.
MY AVAILABILITY IS: defines the state of availability for the time slot given that the topic pattern is satisfied.
Values can be either binary: AVAILABLE, NOT AVAILABLE, or can be also fuzzy, e.g., “MAYBE AVAILABLE” based on topic proximity,
or even user defined, e.g., “PLEASE CONTACT ME BEFORE INVITATION”.
ELSE MY AVAILABILITY IS: an alternative availability definition in case the topic definition pattern is not satisfied.

For example, a user that does not wish to be invited to meetings during his/her more busy works hours on his/her projects “project 1” OR “project 2” can use the following rule to define his/her topic-based calendar availability: FROM 12/10/2010 10:00 GMT TO 12/10/2010 14:00 GMT IF TOPIC IS “project 1” OR “project 2” THEN MY AVAILABILITY IS AVAILABLE ELSE MY AVAILABILITY IS NOT AVAILABLE

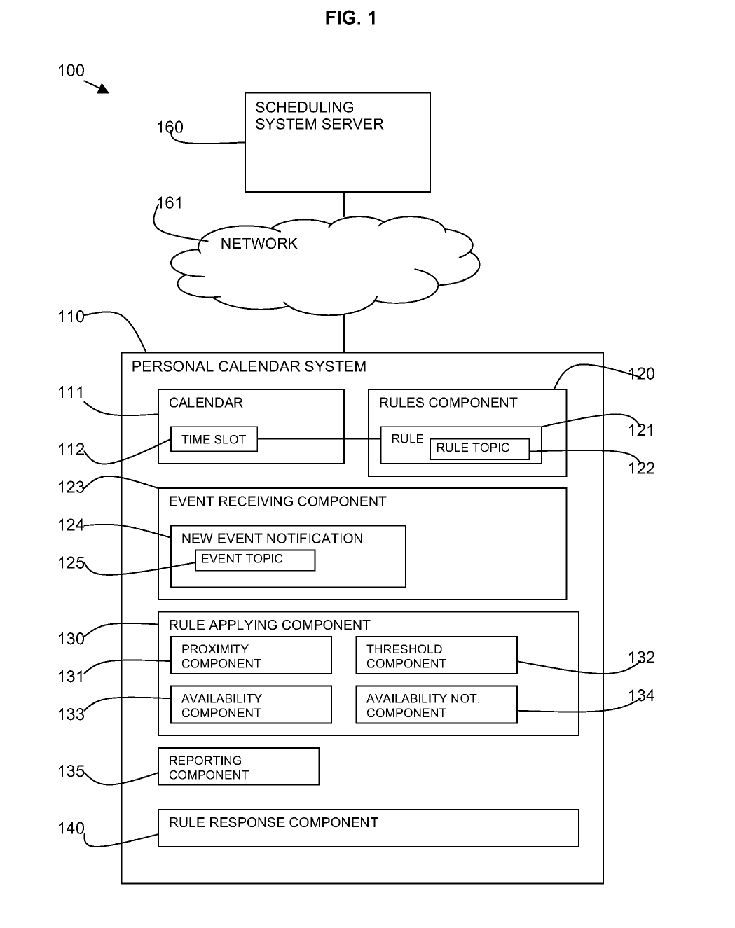

Referring to FIG. 1, a block diagram shows an embodiment of a first aspect of the described system.

A scheduling system 100 includes multiple users' personal calendar systems 110 in communication via a network 161 via a scheduling system server 160. The details of the personal calendar systems 110 may be made available to other users or a coordinator wishing to schedule an event via the scheduling system server 160.

A personal calendar system 110 generally includes a calendar 111 with time slots 112 for which events such as meetings, telephone or online conferences, tasks, other appointments, etc. may be scheduled or booked. A user may designate time slots 112 as being unavailable, available, already scheduled, etc. The calendar 111 or a copy of the calendar 111 may be stored at the scheduling system server 160.

In the described system, a personal calendar system 110 includes a rules component 120 for the user to define rules 121 regarding topic based availability. The rules 121 may include: a specified time slot, a rule topic 122, a threshold for similarity to the topic, and availability for the topic in the time slot. A time slot 112 in the calendar 111 may have a rule associated with it.

Rules 121 on topic-based availability for time slots of a user may be made available to other users or to a manager/coordinator via the scheduling system server 160 in order to help the other user or manager/coordinator to schedule new events.

The personal calendar system 110 may include an event receiving component 123 for receiving a new event notification 124. A new event notification 124 may include notification of a time slot, an event topic 125, and any other relevant information.

In a first embodiment, checking the topic-based availability may be carried out at the personal calendar system 110 and the event receiving component 123 invokes a rule applying component 130.

The rule applying component 130 may include a proximity component 131 for calculating the proximity between the event topic 125 of the new event notification 124 and the rule topic 122 of the rule 121 defined for the specified time slot of the new event notification 124. The proximity component 131 may include any type of proximity measure, for example, similarity based on text/taxonomy concepts (synonyms)/edit distance, etc. Text/concept similarity may be calculated, for example, using any string based similarity, e.g., cosine (vector space) similarity, Jaccard similarity, Levinstein edit distance, Normalized Google distance (Google is a trade mark of Google, Inc.), etc.

The rule applying component 130 may include a threshold component 132 to determine if the proximity of topic is within the defined threshold of the rule 121.

An availability component 133 may determine the availability status according to the rule 121 based on the outcome of the topic proximity and threshold. An availability notification component 134 may provide a response to the new event notification 124 with the determined availability status.

A reporting component 135 may be provided to generate an alert for the user of the personal calendar system 110 to notify the user that an event has been declined due to the topic's availability status. This enables the user to re-evaluate his topic rules, if necessary.

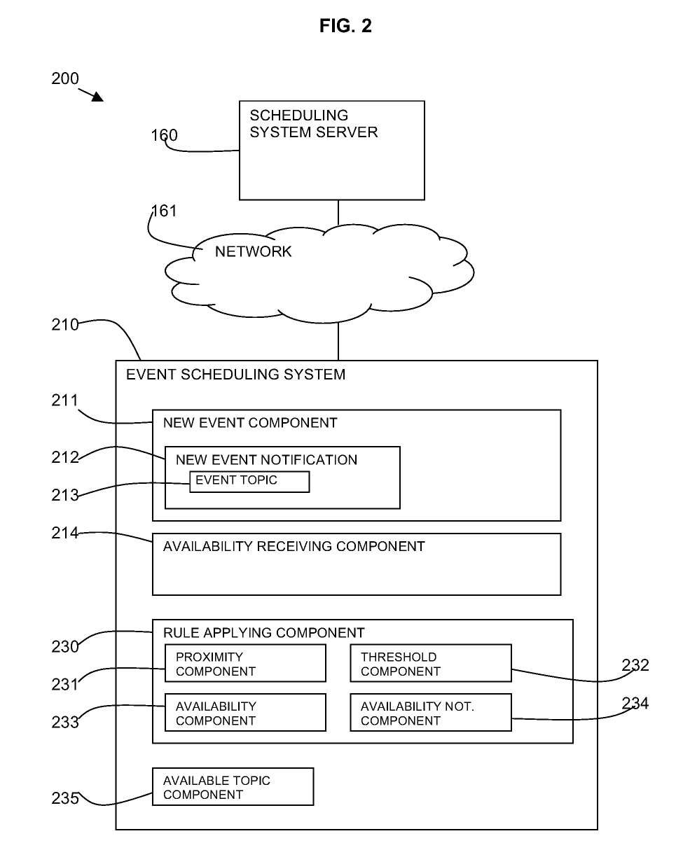

In a second embodiment, checking the topic-based availability may be carried out at a new event scheduling system shown in FIG. 2. The new event scheduling system may be a scheduling user's personal calendar system, or may be a manager's system with access to the scheduling system server. In this case, the personal calendar system 110 replies to the new event notification 124 using a rule response component 140 which sends the relevant rule 121 for the time slot of the new event notification 124 to the new event scheduling system which determines the availability of all the invitees according to their rules.

Referring to FIG. 2, a block diagram shows an embodiment of a further aspect of the described system.

A user of a personal calendar system or a manager or coordinator, may schedule a new event using an event scheduling system 210. The event scheduling system 210 may be part of a personal calendar system 110, a manager system, etc. The event scheduling system 210 may communicate with personal calendar systems 110 of invitees via a scheduling system server 160 via a network 161.

An event scheduling system 210 includes a new event component 211 which may define a new event notification 212 including at least a time slot, an event topic 213, and one or more invitees. The new event notification 212 may be sent to the one or more invitees' personal calendar systems 110 via the scheduling system server 160.

In a first embodiment, the topic-based availability is checked at the individual invitee's personal calendar systems 110 and an availability receiving component 214 receives responses from the one or more invitees' personal calendar systems 110 providing their availability status for the new event. The event may then be confirmed or rescheduled.

In a second embodiment, a new event scheduling system 210 may include a rule applying component 230 which may obtain any rules from invitees from the scheduling system server 160 defining their topic-based availability for a time slot for a new event. This enables an event scheduler to determine the best time slot for a new event for a given topic before sending a new event notification.

The rule applying component 230 includes a proximity calculating component 231 for calculating the proximity between the topic of the new event notification 212 and the topic of the retrieved rule 221 defined for the specified time slot of the new event notification 212. The rule applying component 230 may include a threshold determining component 232 to determine if the proximity of topic is within the defined threshold of the rule 221. An availability component 233 may determine the availability status according to the rule 221 based on the outcome of the topic proximity and threshold.

In another embodiment, a scheduling system of a manager or coordinator, may access users' rules from the scheduling system server 160 in order to be able to coordinate new events based on the rules.

In another embodiment, an available topic component 235 may be provided, wherein given the list of invitees and the time slot select for the event, a list of topics may be presented to the coordinator that he may schedule an event for at that time slot. One way to do this is to show for each invitee the list of topics that this invitee allows to be invited to at that time slot.

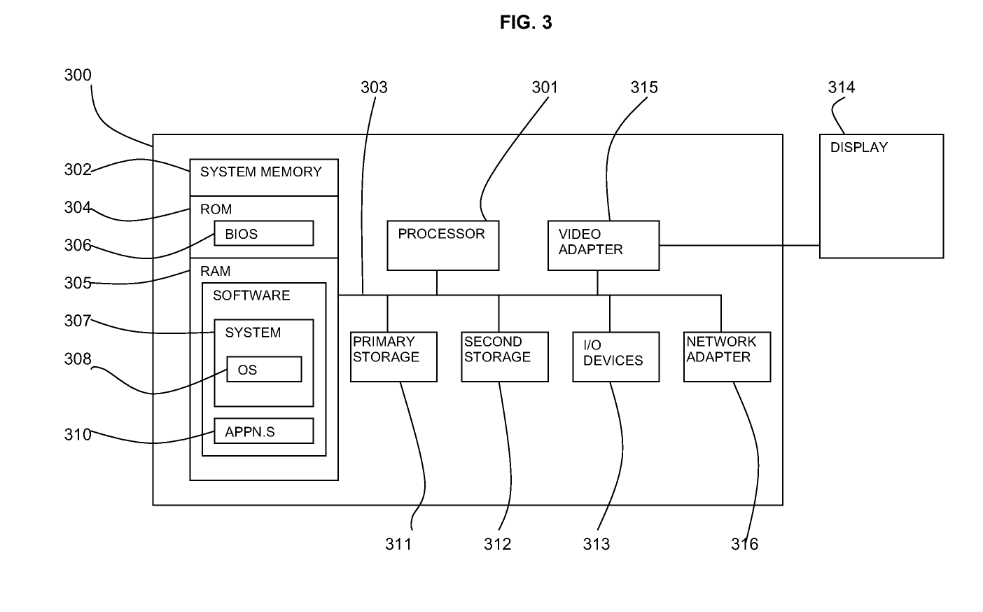

Referring to FIG. 3, an exemplary system for implementing aspects of the invention includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

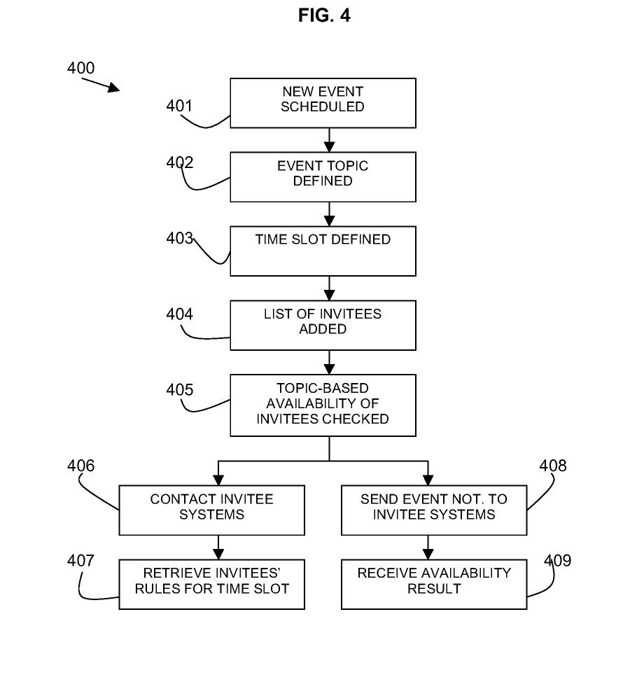

Referring to FIG. 4, a flow diagram 400 shows an aspect of the described method at a scheduling system.

A new event to be scheduled is created 401. A topic of the event is defined 402 and optional description or metadata, e.g., tags, may be added. Tags can be any free text annotations which the event coordinator may tag with to further describe the event. Additional metadata may be further generated from a selection of taxonomy concepts. For example, the event coordinator may use some internal taxonomy which enable him to select (classify) the event as related to topic “Hardware\Compilers”.

A proposed time slot is defined 403 for the event and a list of invitees is added 404. Topic-based availability of the invitees is then checked 405.

The topic-based availability check may be done automatically by the system contacting 406 each invitee's personal calendar system and retrieving 407 the invitee's rules for the specified time slot. Alternatively, the topic-based availability may be obtained by sending 408 an event notification to invitees' personal calendar systems which apply the topic-based availability rules and return 409 the availability result.

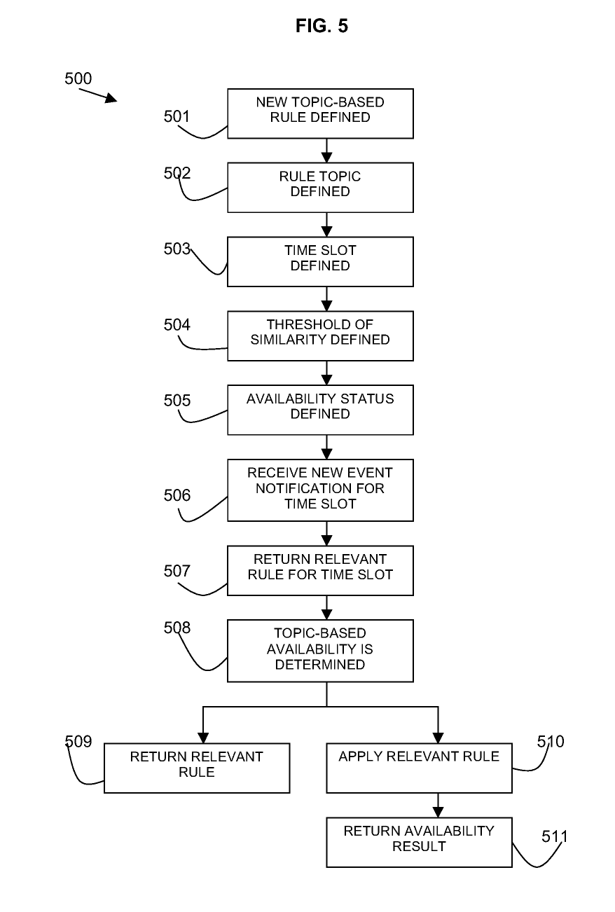

Referring to FIG. 5, a flow diagram 500 shows an aspect of the described method at a personal calendar system.

A new topic-based rule is defined 501 including defining 502 a topic of the rule, defining 503 a time slot of the rule, defining 504 a threshold of similarity, and defining 505 an availability status.

A personal calendar system receives 506 a new event notification and retrieves 507 the rule for the time slot. A topic-based availability is determined 508.

The topic-based availability may be determined 508 by returning 509 the relevant rule for the time slot to the scheduler who applies the rule. Alternatively, the topic-based availability may be determined 508 by the personal calendar system applying 510 the rule and returning 511 the availability result.

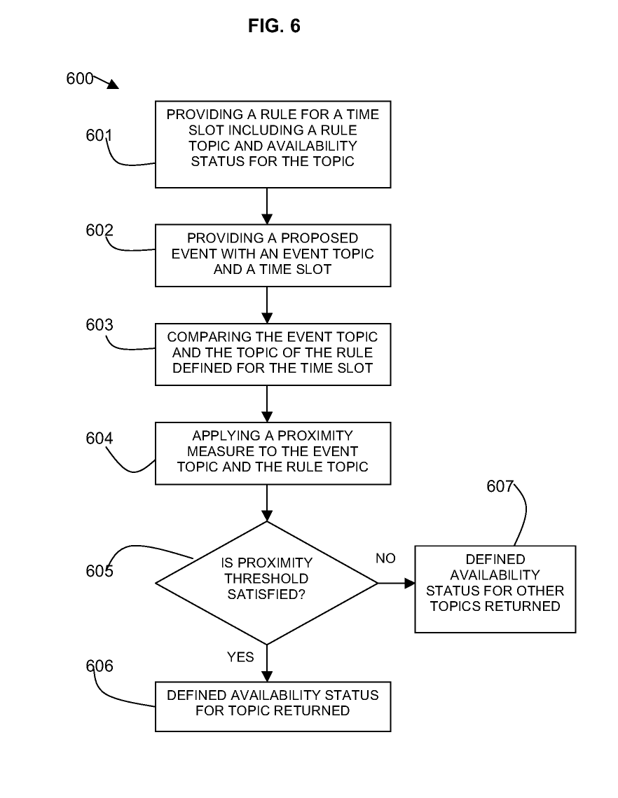

Referring to FIG. 6, a flow diagram 600 shows the described method of applying topic-based rules.

The method is carried out having a rule for a time slot 601 including a rule topic and an availability status for the rule topic and having a proposed event 602 with an event topic for a time slot. The method may be carried out either at a scheduler's system wherein the scheduler provides the proposed event and receives a relevant rule, or at an invitee's system wherein the invitee provides the rule and receives a proposed event.

For each invitee to the proposed event, the event topic is compared 603 to the rule topic defined for the time slot. A proximity measure is applied 604 to determine the similarity of the event topic and the rule topic. Optionally additional metadata may be provided relating to the event topic and/or the rule topic which may be used in the proximity measure.

It is determined 605 if a proximity threshold is satisfied which determines if the event topic and rule topic are sufficiently similar for a match to be made. If so, a defined availability for the topic is returned 606 for the invitee. If not, a defined availability for other topics is returned 607 for the invitee.

Based on the topic proximity threshold value different colors may be used to denote the derived availability of each individual. For example, a scale from red 0% to green 100% may be used.

The different topic-based availability rules of the different invitees can be further used to help the coordinator to locate time slots in which the topic-based agreement (focus) for the schedule event is maximized. It can also help to explain to a coordinator why the scheduling of some event in the defined time slot is problematic.

In another embodiment, given the list of event participants and the time slot select for the event, a suggestion may be presented to the coordinator or the list of topics that he may schedule meeting about at that time slot. One way to do this is to show for each invitee the list of topics that this invitee allows to be invited to at that time slot.

In a further embodiment, users may get notifications about event topics that others tried to invite them to but could not since their topic rules did not allow it. This can help users to refine/adjust their rules if they wish to.

A topic-based availability system may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for topic-based calendar availability, comprising:
having a rule for a time slot in a calendar, wherein the rule includes a rule topic and an availability status for the topic;
having a proposed event with an event topic and a time slot;
comparing a proposed event topic and a rule topic for the rule for the time slot of the proposed event;
applying a proximity measure to the event topic and rule topic to determine a match;
providing the availability status for the topic if the event topic matches the rule topic;
wherein said steps are implemented in either:
computer hardware configured to perform said steps, or
computer software embodied in a non-transitory, tangible, computer-readable storage medium.

2. The method as claimed in claim 1, wherein having a rule for a time slot includes having a threshold value for the similarity required of the event topic to the rule topic.

3. The method as claimed in claim 2, wherein if no threshold value is provided, a default threshold value is used.

4. The method as claimed in claim 1, including providing a defined alternative availability status if the event topic does not match the rule topic.

5. The method as claimed in claim 1, including having a rule including additional metadata of the rule topic and using the additional metadata in comparing the rule topic to an event topic.

6. The method as claimed in claim 1, wherein a proximity measure includes one of the group of: similarity based on text, similarity based on taxonomy, edit distance, string based similarity.

7. The method as claimed in claim 1, wherein having a rule for a time slot in a calendar includes having the rule for one or more topics.

8. The method as claimed in claim 1, wherein the method is carried out at an invitee's personal calendar system when an invitation is received for a proposed event.

9. The method as claimed in claim 1, wherein the method is carried out at a scheduler's system and the rules are retrieved for invitees of a proposed event.

10. The method as claimed in claim 1, including providing a list of topics available for event scheduling for each invitee for a given time slot.

11. The method as claimed in claim 1, including reporting to a user about an event they were invited to and shown as unavailable due to their rules.

12. A computer program product, the computer program product for topic-based calendar availability comprising:
a computer readable storage medium having computer readable program code embodied therewith, the computer readable program code comprising:
computer readable program code configured to:
have a rule for a time slot in a calendar, wherein the rule includes a rule topic and an availability status for the topic;
have a proposed event with an event topic and a time slot;
compare a proposed event topic and a rule topic for the rule for the time slot of the proposed event;
apply a proximity measure to the event topic and rule topic to determine a match; and
provide the availability status for the topic if the event topic matches the rule topic.

13. A system for topic-based calendar availability, comprising:
a processor;
a rules component for having a rule for a time slot in a calendar, wherein the rule includes a rule topic and an availability status for the topic;
an event component for having a proposed event with an event topic and a time slot;
a rule applying component including:
a proximity component for comparing a proposed event topic and a rule topic for the rule for the time slot of the proposed event and applying a proximity measure to the event topic and rule topic to determine a match; and
an availability component for providing the availability status for the topic if the event topic matches the rule topic.

14. The system as claimed in claim 13, wherein the rule for a time slot includes providing a threshold value for the similarity required of the event topic to the rule topic and the rule applying component includes:
a threshold component for determining if a proximity of an event topic and a rule topic are within the threshold for a match.

15. The system as claimed in claim 13, wherein a rule includes a defined alternative availability status if the event topic does not match the rule topic.

16. The system as claimed in claim 13, wherein a rule includes additional metadata of the rule topic and the proximity component uses the additional metadata in comparing the rule topic to an event topic.

17. The system as claimed in claim 13, wherein the proximity component includes a proximity measure of one of the group of: similarity based on text, similarity based on taxonomy, edit distance, string based similarity.

18. The system as claimed in claim 13, wherein a rule for a time slot in a calendar includes providing the rule for one or more topics.

19. The system as claimed in claim 13, wherein a scheduling system server provides topic-based rules to an event coordinator.

20. The system as claimed in claim 13, wherein the availability component denotes the availability as a scale of colors from available to unavailable.

21. The system as claimed in claim 13, wherein the rule applying component is provided at a user's personal calendar system.

22. The system as claimed in claim 13, wherein the rule applying component is provided at an event scheduling system.

23. The system as claimed in claim 13, including an available topic component for providing a list of topics available for event scheduling for each invitee for a given time slot.

24. The system as claimed in claim 13, including a reporting component for reporting to a user about an event they were invited to and shown as unavailable due to their rules

25. A method of providing a service to a customer over a network for topic-based calendar availability, the service comprising:
having a rule for a time slot in a calendar, wherein the rule includes a rule topic and an availability status for the topic;
having a proposed event with an event topic and a time slot;
comparing a proposed event topic and a rule topic for the rule for the time slot of the proposed event;
applying a proximity measure to the event topic and rule topic to determine a match; and
providing the availability status for the topic if the event topic matches the rule topic.
